(19) United States
(12) Patent Application Publication
(10) Pub. No.: US 2018/0115203 A1
(43) Pub. Date: Apr. 26, 2018

(54) STARTER STATOR FOR A MOTOR VEHICLE WITH AN OPTIMISED REMANENCE RANGE

(71) Applicant: VALEO EQUIPEMENTS ELECTRIQUES MOTEUR, Creteil Cedex (FR)

(72) Inventors: Jean-Marc DUBUS, Combs La Ville (FR); Nicolas LABBE, Lyon (FR); Raphaël ANDREUX, Lyon (FR); Aymeric DERVILLE, Lyon (FR)

(73) Assignee: VALEO EQUIPEMENTS ELECTRIQUES MOTEUR, Creteil Cedex (FR)

(21) Appl. No.: 15/561,902

(22) PCT Filed: Apr. 7, 2016
(86) PCT No.: PCT/FR2016/050790

§ 371 Date: Sep. 26, 2017

(30) Foreign Application Priority Data
Apr. 7, 2015 (FR) 1552944

(51) Int. Cl. H02K 1/17; H02K 1/02

(52) U.S. Cl. CPC H02K 1/17; F02N 11/00; H02K 1/02

(57) ABSTRACT

The invention mainly relates to a motor vehicle starter stator (3) comprising: —a cylinder head (4); and —a set of permanent magnets (5) mounted against an inner face (41) of the cylinder head (4). Each permanent magnet (5) from the set is magnetically oriented in a radial manner. The stator is characterized in that the mean remanence of the permanent magnet set (5) is within a range of between 0.73 and 0.87 Tesla, in particular between 0.78 and 0.83 Tesla, and preferably between 0.79 and 0.81 Tesla.

The present invention relates to a starter stator for a motor vehicle with an optimised remanence range.

Starters for motor vehicles are known which are provided with a stator, or inductor, comprising a plurality of permanent magnets, and a rotor, or armature, provided with a body with a cylindrical form and a winding formed by conductive wires.

In a known manner, the inductor comprises a metal head, the inner face of which supports a plurality of permanent magnets which are designed to produce an inductive field. The permanent magnets are formed according to cylindrical segments, which are angularly distributed at regular intervals inside the head, and are separated uniformly from the armature by a radial air gap. Ferrite magnets exist, the basic remanence of which is approximately 0.4 Tesla. The permanent magnets are generally secured on the inner face of the head by means of clips which extend in the longitudinal direction, in the intervals provided between the permanent magnets. The dimensions of the thickness of the head are established relative to the magnets, and also, because of the mechanical characteristics required, this thickness must be between 1.5 mm and 3.5 mm. Because of the greater Tesla for wound inductor starters, it is usual to use a head thickness of 4 mm or more.

In addition, the rotor body consists of a set of metal plates with longitudinal notches in which the wires of the winding are inserted, constituted for example by conductors in the form of a pin. The rotor is also provided with a collector comprising a plurality of contact parts which are connected electrically to the wires of the winding.

In certain types of starter, premature wear of the brushes by electro-erosion has been found. In order to solve this problem of wear, the invention proposes to reduce the amplitude of the current signal which passes through the brushes, and to compensate for this decrease of current in the machine by an increase in the intensity of the induction produced in the air gap between the inductor and the armature. However, it is not possible to increase excessively the intensity of the induction produced in the air gap, since otherwise it would become necessary to increase the thickness of the head in order to prevent its magnetic saturation, which would cause problems of size of the starter.

The invention thus proposes a stator comprising a set of permanent magnets with remanence within a specific range of values which makes it possible to compensate for the loss of power of the machine caused by the decrease in current, without needing to increase the dimensions of the head.

More specifically, the subject of the invention is a stator of a motor vehicle starter, comprising:
a head;
a set of permanent magnets fitted against an inner face of the said head, each of the permanent magnets of the said set being magnetically oriented radially,
   characterised in that the mean remanence of the said set of permanent magnets is in a range between 0.5 and 0.9 Tesla, in particular between 0.59 and 0.83 Tesla, and preferably between 0.6 and 0.81 Tesla.

This therefore reduces the wear of the brushes whilst having magnets which can be fitted in a head which is according to the prior art on the basis of its necessary mechanical characteristics. In fact, this range of values makes it possible to decrease the current which passes through the brushes, whilst keeping the starter heads according to the prior art with only ferrite magnets. If use is made only of magnets of the rare earth type, which comprise remanence greater then 0.9 Tesla, in this case approximately 1.2 Tesla, it would be necessary to increase the thickness of the head in of the head in order to utilise all of its useful intensity in the air gap. An increase of this type of the head would increase the weight of the starter, as well as increase the cost significantly. In addition, a starter inductor with a high mean level of remanence such as 1.2 Tesla would have an excessively high basic remanence, which would give rise to problems of the mean speed of the motor, and in particular a decrease in the mean drive speed at low temperatures. In fact, this decrease in speed would be caused in particular by transitory speed inertia phenomena with acyclism of the thermal engine caused by the compressions-expansions of the thermal engine to be driven.

In addition, in the case when use would be made only of magnets with remanence greater than 0.9 Tesla, such as, for example, only permanent magnets comprising neodymium-iron-boron rare earth at 1.2 Tesla (which is very expensive) with a head of the same thickness as in the prior art, the head would be saturated magnetically, and would therefore not increase the performance. The increase in the mean remanence thus makes it possible to increase sufficiently the intensity of the induction produced in the air gap, in order to increase the service life.

Set of magnets means all the magnets of the stator of the starter forming the inductor.

According to one embodiment, the said stator comprises at least one permanent magnet comprising at least one element of the rare earth type such as neodymium Nd or samarium Sm (known as a rare earth type magnet).

According to one embodiment, the said set of permanent magnets comprises six magnets forming six poles.

According to one embodiment, the said set of permanent magnets comprises four magnets forming four poles.

According to one embodiment, the said set of permanent magnets comprises a first sub-set of magnets of the rare earth type, and a second sub-set of magnets made of ferrite.

According to one embodiment, the stator comprises magnets of the first sub-set between magnets of the second sub-set. In particular, the magnets of the first sub-set alternate with the magnets of the second sub-set.

According to one embodiment, the said first sub-set of magnets comprises half of the total number of magnets of the said stator which are made of neodymium-iron-boron, and the second sub-set of magnets comprises the other half of the total number of magnets of the said stator made of ferrite.

According to one embodiment, the said first sub-set of magnets comprises four magnets made of samarium cobalt, and the said second sub-set of magnets comprises four magnets made of ferrite.

According to one embodiment, the said permanent magnets of the said set each have the same remanence value. This makes it possible to balance the magnetic field produced by the stator.

According to one embodiment, each permanent magnet of the said set is constituted by a plasto-magnet.

According to one embodiment, each or the plastic-magnet(s) is/are made of neodymium-iron-boron. In this case, the plasto-magnet is compacted in hot conditions.

According to one embodiment, each plasto-magnet is made of samarium-iron-nitrogen.

According to one embodiment, each permanent magnet of the said set is made of Neolit NQ 2F (registered trademark) which in particular is compacted in hot conditions.

According to one embodiment, the said permanent magnets are retained against the said head by means of clips.

The invention also relates to a starter comprising a rotary electrical machine provided with a stator as previously defined.

According to one embodiment, a reduction ratio of the said starter is between 3.5 and 5, and is preferably 4.

In fact, another solution for increasing the service life of the brushes is to reduce the reduction ratio in order to decrease the torque and therefore the current in the brush. However, for some thermal engines, it is necessary to have a reduction ratio of between 3.5 and 5, and preferably 4, in order to have sufficient torque to ensure the starting of this type thermal engine, in particular when it is cold.

The invention also relates to a starter comprising a first sub-set of magnets of the rare earth type, and a second sub-set of magnets made of ferrite.

This therefore provides a starter which makes it possible to increase the number of cycles of the brushes, by replacing some of the ferrite magnets of the starter according to the prior art by magnets of the rare earth type, without modifying the structure of the starter. A starter of this type is slightly more expensive than a ferrite starter, but it increases the number of cycles of the starter, and is less costly than a starter comprising a single rare earth magnet or more than one.

According to one embodiment, the stator comprises magnets of the first sub-set between magnets of the second sub-set. In particular, the magnets of the first sub-set alternate with the magnets of the second sub-set.

The invention also relates to, the said first sub-set of magnets comprises half the total number of magnets of the said stator made of neodymium-iron-boron, and the second sub-set of magnets comprises the other half of the total number of magnets of the said stator made of ferrite.

According to one embodiment, the said first sub-set of magnets comprises four magnets made of samarium cobalt, and the second sub-set of magnets comprises two magnets made of ferrite.

The invention also relates to a starter comprising a stator comprising one or more plasto-magnets.

According to one embodiment, the or each plasto-magnet is made of neodymium-iron-boron.

According to one embodiment, each plasto-magnet is made of samarium-iron-nitrogen.

According to one embodiment, each permanent magnet of the said set is made of Neolit NQ 2F (registered trademark) which in particular is compacted in hot conditions.

The invention will be better understood by reading the following description and examining the figures which accompany it. These figures are provided purely by way of illustration of the invention, and are in no way limiting.

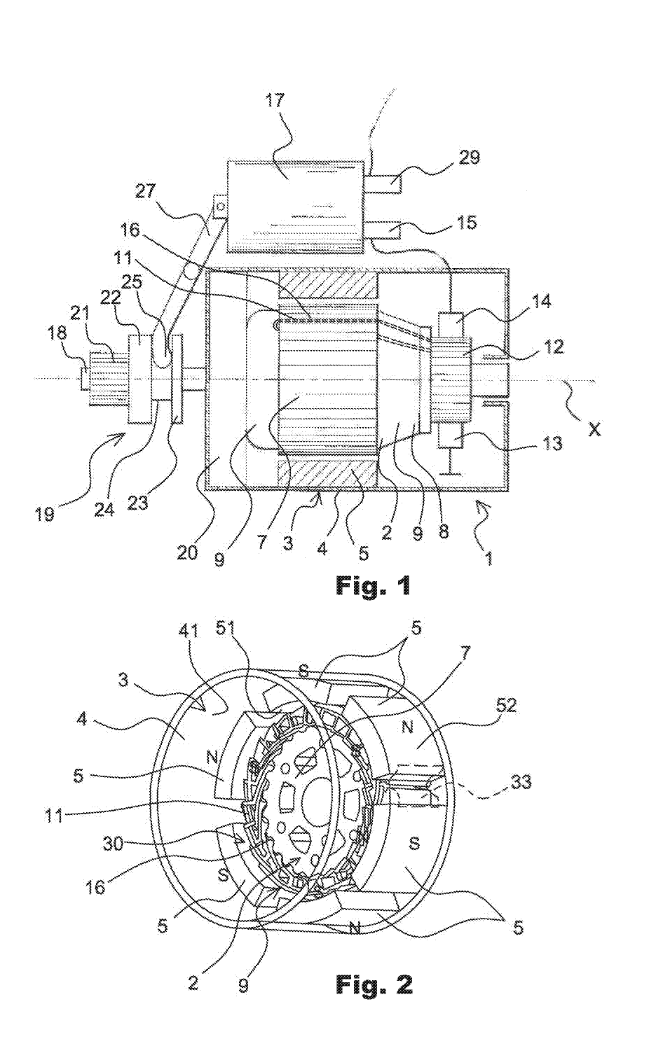

FIG. 1 is a schematic side view of a starter according to the present invention;

FIG. 2 is a schematic view in perspective of the stator with permanent magnets of the starter in FIG. 1;

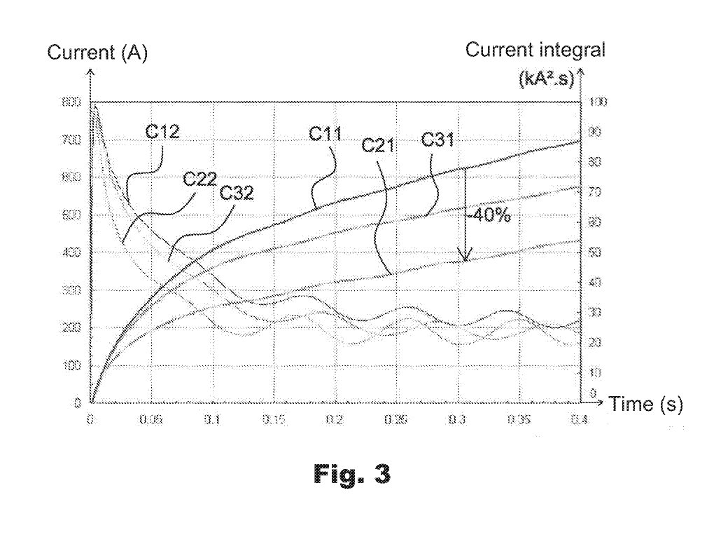

FIG. 3 represents current curves and corresponding current integral curves for different configurations of sets of permanent magnets and of the reduction ratio of the starter.

Elements which are identical, similar or analogous retain the same references from one figure to another.

FIG. 1 shows schematically a starter 1 for an internal combustion engine of a motor vehicle. This direct current starter 1 comprises firstly a rotor 2, also known as an armature, which can rotate around an axis X, and secondly a stator 3, also known as an inductor, positioned around the rotor 2. In the example illustrated, the rotary electrical machine formed by the stator 3 and the rotor 2 is of the six pole type.

This stator 3, described in detail hereinafter, comprises a head 4 which supports a set of permanent magnets 5.

The rotor 2 comprises a rotor body 7 and a winding 8 which is wound in notches in the rotor body 7. The rotor body 7 consists of a set of metal plates which have longitudinal notches. In order to form the winding 8, conductive wires in the form of a pin 11 (shown more clearly in FIG. 2) are inserted inside notches 16, generally on two distinct layers. The winding 8 forms chignons 9 on both sides of the rotor body 7.

At the rear, the rotor 2 is provided with a collector 12 comprising a plurality of contact parts which are connected electrically to the conductive elements, formed in the example concerned by the pins 11 of the winding 8.

A set of brushes 13 and 14 is provided for the electrical supply of the winding 8, one of the brushes 13 being connected to the earth of the starter 1, and another one of the brushes 14 being connected to an electrical terminal 15 of a contactor 17. There are for example four brushes.

The brushes 13 and 14 rub on the collector 12 when the rotor 2 is rotating, thus making possible the power supply to the rotor 2 by switching of the electric current in sections of the rotor 2.

In addition to the terminal 15 which is connected to the brush 14, the contactor 17 comprises a terminal 29, which is connected, via an electrical connection element, to an electrical supply of the vehicle, in particular a battery.

The starter 1 also comprises a launcher assembly 19 which is fitted such as to slide on a drive shaft 18, and can be rotated around the axis X by the rotor 2.

A speed reducer assembly 20 is interposed between a shaft of the rotor 2 and the drive shaft 18. The launcher assembly 19 comprises a drive element which is formed by a pinion 21, and is designed to engage on a drive unit of the thermal engine, such as a drive crown. As a variant, it would be possible to use a pulley system.

The launcher assembly 19 also comprises a free wheel 22 and a pulley washer 23, which define between them a groove 24 in order to receive the end 25 of a fork 27. This fork 27 is produced for example by moulding a plastic material.

The fork 27 is activated by the contactor 17, in order to displace the launcher assembly 19 relative to the drive shaft 18, along the axis X, between a first position in which the launcher assembly 19 drives the thermal engine by means of the drive pinion 21, and a second position in which the launcher assembly 19 is disengaged from the drive crown of the thermal engine. During the activation of the contactor 17, an internal contact plate (not represented) makes it possible to establish a connection between the terminals 15 and 29, in order to switch on the electric motor. This connection will be cut off during the deactivation of the contactor 17.

As can be seen in FIG. 2, the stator 3 comprises the tubular metal head 4 and the set of permanent magnets 5 which are designed to produce an inductive field. The magnets 5 are fitted against an inner face 41 of the head 4. The permanent magnets 5 are formed according to cylindrical segments, whilst being angularly distributed at regular intervals inside the head 4, and separated uniformly from the rotor 2 by a radial air gap 30.

Each of the magnets 5 is magnetically oriented radially, i.e. each magnet 5 has an inner face 51 with a given polarity (North or South) oriented on the side of the air gap 30, and an outer face 52 with the opposite polarity oriented on the side of the head 4. In addition, as can be seen clearly in FIG. 2 where the letters N and S correspond respectively to the North and South poles, two consecutive magnets 5 have alternating polarities. Thus, the inner faces 51 which face towards the air gap 30 have alternating polarity, and the outer faces 52 which face towards the head have alternating polarity according to the circumference of the stator 3.

The magnets 5 are generally secured on the inner face 41 of the head 4 by means of clips 33 which extend in the longitudinal direction in the intervals provided between the magnets 5. In this case, a single clip 33 has been represented in order to improve the legibility of the figure, but it is clear that the stator comprises a clip 33 between each set of two adjacent magnets 5. The securing of the clips 33 ensures in particular spacing between the magnets 5, in order to create a uniform inductive field in the air gap 30, as well as axial and radial retention of the magnets 5 in the head 4, by opposing the mechanical forces (vibrations, impacts), and the magnetic attraction forces during the operation of the motor.

Preferably, the mean remanence of the set of magnets 5 is in a range between 0.73 Tesla and 0.87 Tesla, in particular from 0.78 to 0.83, and preferably between 0.79 and 0.81. The mean remanence is defined as being the sum of the remanences of each of the magnets 5 of the set, divided by the number of magnets 5 of the set.

The set of magnets comprises a first sub-set of magnets 5, comprising rare earth elements such as neodymium Nd or samarium Sm, and a second sub-set of magnets 5 made of ferrite. The first sub-set comprises half the total number of magnets 5 of the stator 3 which are made of neodymium-iron-boron, and the second sub-set comprises the other half of the total number of magnets 5 of the stator 3 which are made of ferrite. The magnets 5 made of neodymium-iron-boron, and the magnets 5 made of ferrite, are positioned alternately according to the circumference of the head 4.

In the case when the set of permanent magnets 5 comprises six magnets forming six poles, three magnets 5 made of neodymium-iron-boron are thus used, each having a remanence of 1.2 Tesla, and three magnets 5 made of ferrite, each having a remanence of between 0.4 Tesla and 0.45 Tesla. The mean remanence of the set is then equal to 0.825 Tesla.

In the case when the set of permanent magnets 5 comprises four magnets 5 forming four poles, two magnets 5 made of neodymium-iron-boron are used, each having a remanence of 1.2 Tesla, and two magnets 5 made of ferrite, each having a remanence of 0.45 Tesla. The mean remanence of the assembly is again equal to 0.825 Tesla.

In another embodiment, for a set of permanent magnets 5 with six poles, the first sub-set comprises four magnets 5 made of samarium cobalt, each with a remanence of 1.02 Tesla, and the second sub-set comprises two magnets 5 made of ferrite, each having a remanence of 0.45 Tesla. The mean remanence of a set of this type is 0.83 Tesla. All the aforementioned magnets 5 are preferably sintered magnets.

The fact that the magnets 5 are of different types and have remanences with different values can give rise to imbalance in the magnetic field produced. In order to prevent this, all the magnets 5 of the set can have the same remanence value.

Thus, in a particular embodiment, each magnet 5 of the stator 3 is constituted by a plasto-magnet with a remanence of 0.8 Tesla. Each plasto-magnet can for example be made of neodymium-iron-boron, or of samarium-iron-nitrogen.

Alternatively, each magnet 5 of the stator 3 is made of Neolit NQ 2F (registered trademark) compacted in hot conditions, with a remanence of 0.8 Tesla.

In addition, taking into account the gain in torque obtained thanks to the use of the set of magnets 5 previously described, it is possible to decrease the reduction ratio of a starter 1 defined hereinafter as being the ratio between the speed of the internal shaft of the armature of the electric motor, and the speed of the drive shaft 18.

Thus, if the reduction ratio is habitually approximately 4.6, the replacement of the permanent magnets 5 made of ferrite, by one of the sets of permanent magnets previously described, makes it possible to use a reducer assembly 20 with a reduction ratio of approximately 4. However, the value of the reduced reduction ratio selected can vary according to the torque to be provided in order to make a motor of a specific type start, and the configuration of the starter 1. The reduced reduction ratio of the starter 1 will thus preferably be between 3.5 and 5.

As illustrated in FIG. 3, in comparison with the curve C11 of the current integral obtained for an initial configuration of a stator 3 provided with six magnets 5 made of ferrite with a remanence of 0.45 Tesla for a reduction ratio of approximately 4.6, the use of a configuration with three magnets 5 made of neodymium-iron-boron, with a remanence of 1.2 Tesla, and three magnets 5 made of ferrite with a remanence of 0.45 Tesla, and a reduction ratio of approximately 4, makes it possible to reduce the value of the current integral by a ratio of 40% (cf curve C21) and thus to decrease the brush wear of the brushes. Thus, it is possible to increase the service life of the brush of the starter, which is very advantageous for starters of the stop and start type (which make it possible to restart a vehicle, the thermal engine of which stops when the vehicle is at a standstill, for example at a red light), for which a number of cycles of life of approximately 250,000 cycles or more is required, for example 300,000 to 450,000 cycles, whereas this number of cycles of life is less than 100,000 for a starter of a conventional type.

The intermediate curve C31 has been obtained for a stator 3 with a reduction ratio of approximately 5.7, provided with six magnets 5 made of ferrite with a remanence of 0.45 Tesla.

It should be noted that the curves C12, C22 and C32 are current curves corresponding respectively to the different current integral curves C11, C12, C13 associated with the different aforementioned configurations.

It will be appreciated that the foregoing description has been provided purely by way of example, and does not limit the scope of the invention, a departure from which would not be constituted by replacing the different elements by any other equivalents.

1. Stator (3) of a motor vehicle starter (1), comprising:
a head (4);
a set of permanent magnets (5) fitted against an inner face (41) of said head (4), each of the permanent magnets (5) of said set being magnetically oriented radially,
wherein the mean remanence of said set of permanent magnets (5) is in a range between 0.5 and 0.9 Tesla, in particular between 0.59 and 0.83 Tesla, and preferably between 0.6 and 0.81 Tesla.

2. Stator according to claim 1, wherein said stator (3) comprises at least one permanent magnet (5) comprising elements of the rare earth type such as neodymium Nd or samarium Sm.

3. Stator according to claim 1, wherein said set of permanent magnets (5) comprises six magnets forming six poles.

4. Stator according to claim 1, wherein said set of permanent magnets (5) comprises four magnets forming four poles.

5. Stator according to claim 1, wherein said set of permanent magnets (5) comprises a first sub-set of magnets (5) of the rare earth type, and a second sub-set of magnets (5) made of ferrite.

6. Stator according to claim 5, wherein said first sub-set of magnets (5) comprises half of the total number of magnets (5) of said stator (3) which are made of neodymium-iron-boron, and said second sub-set of magnets (5) comprises the other half of the total number of magnets (5) of said stator (3) made of ferrite.

7. Stator according to claim 3, wherein said first sub-set of magnets (5) comprises four magnets (5) made of samarium cobalt, and said second sub-set of magnets (5) comprises four magnets (5) made of ferrite.

8. Stator according to claim 1, wherein said permanent magnets (5) of said set each have the same remanence value.

9. Stator according to claim 8, wherein each permanent magnet (5) of said set is constituted by a plasto-magnet.

10. Stator according to claim 9, wherein each plastic-magnet is made of neodymium-iron-boron.

11. Stator according to claim 9, wherein each plasto-magnet is made of samarium-iron-nitrogen.

12. Stator according to claim 1, wherein each permanent magnet (5) of said set is made of Neolit NQ 2F (registered trademark) which in particular is compacted in hot conditions.

13. Stator according to claim 1, wherein said permanent magnets (5) are retained against said head (4) by means of clips (33).

14. Starter (1) comprising a rotary electrical machine provided with a stator (3) as defined according to claim 1.

15. Starter according to claim 14, wherein a reduction ratio of said starter (1) is between 3.5 and 5, and is preferably 4.

16. Stator according to claim 2, wherein said set of permanent magnets (5) comprises six magnets forming six poles.

17. Stator according to claim 2, wherein said set of permanent magnets (5) comprises four magnets forming four poles.

18. Stator according to claim 2, wherein said set of permanent magnets (5) comprises a first sub-set of magnets (5) of the rare earth type, and a second sub-set of magnets (5) made of ferrite.

19. Stator according to claim 3, wherein said set of permanent magnets (5) comprises a first sub-set of magnets (5) of the rare earth type, and a second sub-set of magnets (5) made of ferrite.

20. Stator according to claim 4, wherein said set of permanent magnets (5) comprises a first sub-set of magnets (5) of the rare earth type, and a second sub-set of magnets (5) made of ferrite.
